(19) United States
(12) Patent Application Publication
(10) Pub. No.: US 2020/0320378 A1
(43) Pub. Date: Oct. 8, 2020

(54) MODEL-BASED DETERMINATION OF A SYSTEM STATE BY MEANS OF A DYNAMIC SYSTEM

(71) Applicant: Siemens Aktiengesellshaft, München (DE)

(72) Inventors: Stefanie Vogl, Konzell (DE); Kai Heesche, München (DE); Hans-Georg Zimmermann, Starnberg/Percha (DE)

(21) Appl. No.: 16/305,751

(22) PCT Filed: May 22, 2017
(86) PCT No.: PCT/EP2017/062239

§ 371 Date: Nov. 29, 2018

(30) Foreign Application Priority Data
Jun. 2, 2016 (DE) 10 2016 209 721.0

(51) Int. Cl. G06N 3/08; G06N 3/04

(52) U.S. Cl. CPC G06N 3/08; G06N 3/0445

(57) ABSTRACT

Provided is a method for the model-based determination of a system status of a dynamic system by means of a model, wherein: a recurrent neural network is provided as the model of the dynamic system; the model is supplied with a time series of potentially recordable measurement values as an input variable, the values comprising recorded and missing measurement values; at least one system status associated with a time point is generated from the model, from which status at least one target value belonging to the respective time point can be determined; sequential system statuses transition into one other by means of a respective status transition; and a correction of at least one system status is carried out on the basis of the time series with the aid of the status transition.

### CROSS-REFERENCE TO RELATED APPLICATIONS

This application claims priority to PCT Application No. PCT/EP2017/062239, having a filing date of May 22, 2016, based off of German Application No. 10 2016 209 721.0, having a filing date of Jun. 2, 2016, the entire contents both of which are hereby incorporated by reference.

### FIELD OF TECHNOLOGY

Physical systems with temporal dynamics can be described by mathematical models. Observables can be observed in physical systems. Vectors having a multiplicity of individual observable values for describing a system state may be involved. Observables can be modeled by means of a model furthermore for specific points in time from system states or system state vectors and thus describe a physical system at this point in time. The point in time here may be in the future, such that observables can be forecast. Mathematical models that derive functional, linear or nonlinear, input-output relationships underlying a system on the basis of historical data are used for time series analysis or for forecasting observable time series. By way of example, use is made of regression models or so-called autoregressive moving average models, or ARMA models for short, or autoregressive integrated moving average or ARIMA models or seasonal ARIMA models, SARIMA models for short, or neural networks. In the sphere of modeling of physical systems or physical processes, the time series of the input and target variables usually originate from sensor measurements. In the case of models which detect and map the temporal dynamics of the underlying system, in particular recurrent neural networks, the data are processed as time series. That is to say that vectors of variables which describe the system at different, successive points in time have to be completely present in order that the entire time series can be processed. It is not possible to remove individual missing time stamps without adversely influencing the model quality. In particular, a system state is modeled which is corrupted by gaps in the time series.

### BACKGROUND

It is known to fill gaps in the time series artificially with the aid of upstream algorithms and then to use the data for modeling. In one particularly simple case, with short gaps the last known measurement value is retained until a new valid measurement is present. If only very few gaps are present overall in a time series, then training patterns containing gaps can be removed from the training data set since this concerns only a small portion of the data. Gaps are filled with entries such as NaN, for example. Training data containing these NaN notes are not used for training. If these are only few in number, then the training amount is not significantly reduced. Furthermore, it is known to carry out various interpolation or extrapolation methods such as e.g. linear or nonlinear interpolation, trigonometrical interpolation or interpolations based on spline functions. In addition to the described methods based on deriving analytical approximation functions, statistical methods in which the distribution functions of the measurement values are taken as a basis are often used as well.

Against this background it is an aspect of embodiments of the present invention to provide a method and a computer program product (non-transitory computer readable storage medium having instructions, which when executed by a processor, perform actions) comprising a computer program for carrying out the method which enable an improved determination of a system state. This aspect is achieved by means of the specified independent claims. Advantageous configurations are specified in the dependent claims.

### SUMMARY

An aspect relates to a method for the model-based determination of a system state of a dynamic system by means of a model,
wherein a recurrent neural network is provided as the model of the dynamic system,
wherein the model is supplied with a time series of potentially detectable measurement values, comprising detected and missing measurement values, as an input variable,
wherein at least one system state associated with a point in time is generated from the model, from which system state at least one target value associated with the respective point in time is determinable;
wherein chronologically successive system states are converted into one another by means of a respective state transition;
wherein a correction of at least one system state is carried out on the basis of the time series with the aid of the state transition;
   characterized in that the correction is carried out without being influenced by the missing measurement values of the time series.

Time-dependent systems can be described particularly advantageously by recurrent neural networks. Since the input variables for the prediction of future time steps are not available, in so-called historically consistent neural networks the input and output variables are replaced by so-called observables, i.e. observable variables. Observables can be detected by measurements for points in time up to the present and can be derived as target variables for arbitrary points in time from a so-called system state or state vector. A system state is based on observables as observable variables and additionally hidden state variables or so-called hidden states.

The modeling can be refined by a procedure in which, for observables of system states in the past, the target values expected on account of the proportion of observables in the system state are replaced by actually detected observables. This is a method based on so-called architectural teacher forcing, or ATF for short, for historically consistent neural networks.

Applying further developed ATF in the sense of the subject matter of the independent claim means that upon the state transition from a state vector at a first point in time t−1 to a state vector of a succeeding point in time t, a correction is carried out which takes account of the fact that a value modeled at the point in time t−1 is possibly not confirmed by a measurement carried out at the point in time t−1, rather there is a deviation between forecast and real measurement. This deviation of the actually observed value from the forecast target value or modeled target value is taken into account for determining the state vector describing the system at the point in time t. The forecast or derivation of a model-based target value is thus improved. In particular the prediction of the target variable vector which is associated with the point in time t and which is derivable from the associated state vector is improved. The target variable vector generally comprises a plurality of target values representing observable variables.

The correction is carried out here if a value within the observable vector was also actually measured or is present. By contrast, if there is a gap in the time series, for example for some or a plurality of entries of one or more observable vectors with respect to different points in time, then these are not taken into account in the correction. Advantageously the correction is carried out only in the case in which a value within the observable vector was also actually measured or is present. In particular, no value which was fixed by an algorithm on the basis of the time series and which was not actually measured at the system is used for the correction. In time steps with missing measurement values, the state vector remains unchanged, that is to say that the target values of the observables for a respective subsequent time step are derived from the internal state of the model. A correction thus fails to occur for entries or observables of a system state or is not carried out if no measurement value is present for the corresponding observable in the preceding state. In this case, a modeled target value is derived purely internally from the state of the model without taking account of the historical measurement data. The correction is thus carried out without being corrupted by missing measurement values.

Advantageously, underlying dynamic processes are not corrupted by the application of interpolation or extrapolation methods for supplementing missing values in a time series. Particularly in the case of sparsely occupied measurement value series in which a high proportion of measurement values are missing, the estimation methods corrupt, inter alia, the statistical properties of the time series, such as mean value or variance, for example, which adversely affects the subsequent modeling. The quality of predictions of the derived models is thus considerably improved on account of embodiments of the invention described. The proposed method for extending a historically consistent neural network model makes it possible to completely dispense with the preprocessing of measurement data and to allow gaps in the data of the time series to be supplemented by the model itself. In this regard, even sparsely occupied time series can be consistently processed and a likewise consistent modeling of the entire underlying dynamics of the system can thus be achieved. Furthermore, no expert knowledge is necessary to choose an appropriate interpolation method manually. Depending on missing observables, an appropriate model would conventionally have to be chosen, with the result that an automation of the correction method has not been possible hitherto with a tenable outlay.

In the case of an erroneous or inappropriate estimation of a value for filling a gap in the observables, as is conventionally carried out, this error continues further and further for predictions. The proposed masking out of individual missing values within the observable vector precludes such corruption with the attendant propagation of an error.

In accordance with one configuration, the correction is carried out without being influenced by the missing measurement values of the time series by virtue of the fact that an observable vector present per point in time of the time series is multiplied by a vector, and said vector is constructed from 0-entries in such a way that the missing measurement values in the observable vector do not influence the correction of the system state as a result of the 0-entries. Accordingly, an index vector is provided which, as a result of 0-entries, in the multiplication, excludes or disregards those values in the observable vector for the correction which were not measured with respect to the previous time step, i.e. for which for example a measurement of a sensor yielded no or no valid or no processable measurement value.

In accordance with one configuration, the correction is carried out without being influenced by the missing measurement values of the time series by virtue of the fact that an observable vector present per point in time of the time series is multiplied by a vector, and said vector is constructed from 1-entries in such a way that the detected measurement values in the observable vector influence the correction of the system state as a result of the 1-entries. The index vector is able, in particular, by means of 1-entries, to take account of some or all of those values in the observable vector for the correction which were actually measured with respect to the previous time step, i.e. for which for example a measurement of a sensor yielded a valid or processable measurement value. For the measurement values actually measured, by way of example, architectural teacher forcing is carried out according to known methods, such that a state vector of the system state with respect to a specific point in time is corrected by the observable vector of the observed time series with respect to the preceding point in time. In this case, it is essential that the 1-entry is not a 0-entry. An extension to entries deviating from a 1-entry is conceivable as long as 0-entries are not involved.

In accordance with one configuration, the missing measurement values of the time series are not supplemented or estimated by an algorithm. In particular, only the measurement values in unchanged form are present as input variables for the observable vector.

In accordance with one configuration, an associated future model-based value is determined from a system state for a point in time in the future with respect to a fixed point in time. Consequently, the method can be used advantageously in particular for the forecast of observables.

In accordance with one configuration, a multiplicity of observable vectors of the time series with respect to past points in time influence the correction of a state vector associated with a point in time following a respective past point in time. Since each ATF per point in time optimizes the respective following system state, a forecast of future values is particularly promising if as many historical values as possible influence the ATF. For a multiplicity of state vectors associated with past points in time, the respective previous observable vectors can have an influence.

In accordance with one development, the correction is carried out in a learning phase of the dynamic system or in an operating phase. The method can thus advantageously be used both for improving the modeling and for improving a forecast. The modeling of observables with respect to a multiplicity of points in time in the past and the coordination with observables actually measured at the respective points in time can firstly be used advantageously to train an HCNN. Likewise, in an operating phase, the ATF can be carried out for a multiplicity of system states of past points in time in order to optimize the prediction of a future observable vector.

In accordance with one configuration, the state transition is performed by applying a nonlinear activation function and a linear function. In particular, functions such as the hyperbolic tangent and linear algebra are used. The state vectors which influence the functions of the state transition have in particular already been rectified by the correction.

In accordance with one configuration, the system state is configured as a state vector composed of observables and hidden states. The correction can be carried out only for the observables; the hidden states describe non-observable variables and are not optimizable by measurements.

In accordance with one configuration, in the state transition a difference vector is applied to the observables of the state vector with respect to the associated point in time, wherein the difference vector describes a difference between the observables and known observables of an associated observable vector of the time series. This involves a customary architectural teacher forcing method, for example, in which the modeled values are replaced by actually measured values from historical time series.

In accordance with one configuration, a value generated from a system state, in particular a forecast future value, for the control of a technical installation, is communicated to a control unit of the technical installation or is used for optimizing the model for the correction.

The embodiment furthermore relates to a computer program product comprising a computer program having means for carrying out the method as claimed in any of the preceding claims if the computer program is executed on a program-controlled device. A computer program product, such as e.g. a computer program means or computer program, can be provided or supplied for example as a storage medium or hardware, such as e.g. memory card, USB stick, CD-ROM, DVD, or else in the form of a downloadable file from a server in a network. This can be implemented for example in a wireless communication network by the transmission of a corresponding file having the computer program product or the computer program means or computer program. In particular, a control device such as, for example, a microprocessor for a smart card or the like is suitable as program-controlled device.

### BRIEF DESCRIPTION

Some of the embodiments will be described in detail, with references to the following Figures, wherein like designations denote like members, wherein:

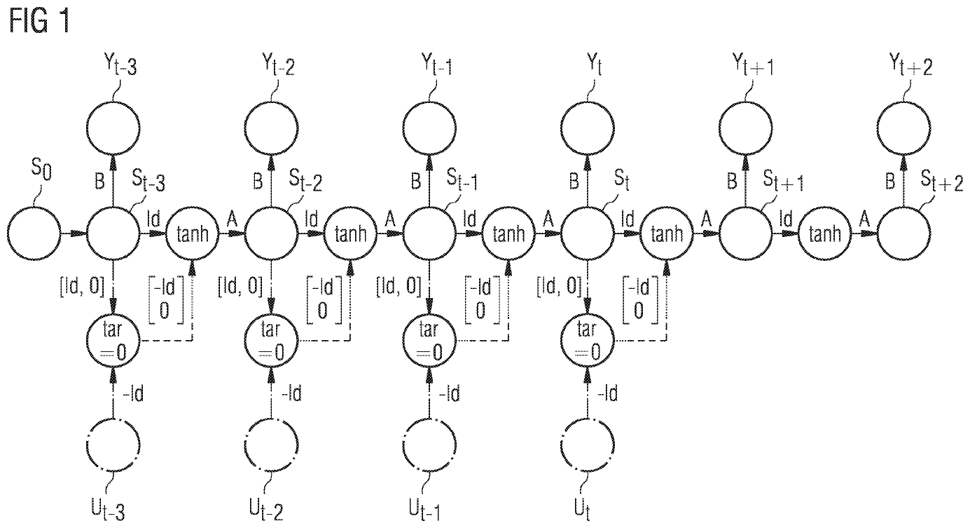

FIG. 1 shows a schematic illustration of a known recurrent neural network for modeling a dynamic system using an architectural teacher forcing correction method; and

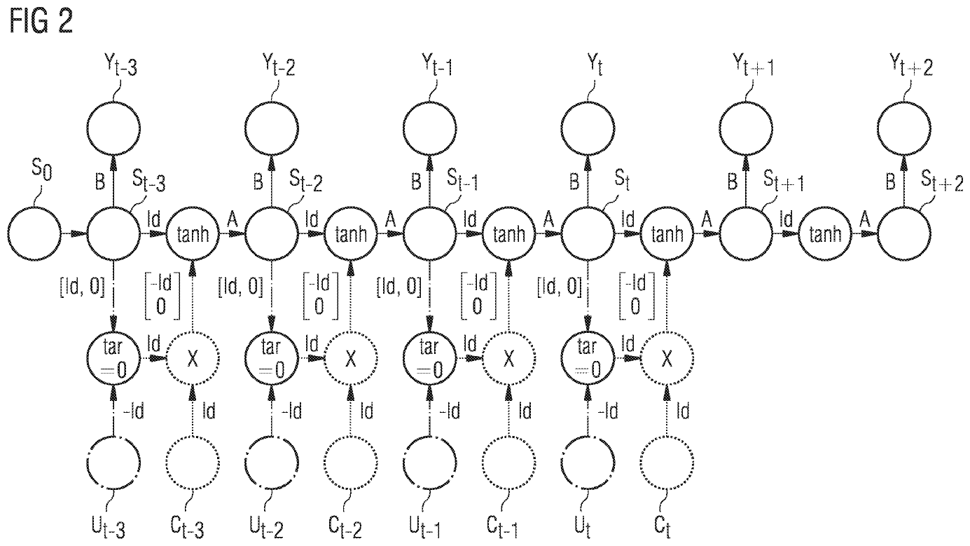

FIG. 2 shows a schematic illustration of a recurrent neural network for modeling a dynamic system using an architectural teacher forcing based correction method in accordance with one exemplary embodiment of the invention.

In the figures, functionally identical elements are provided with the same reference signs, unless indicated otherwise.

### DETAILED DESCRIPTION

Recurrent neural networks for modeling a temporal behavior of a dynamic system generally comprise a plurality of layers which include a plurality of neurons and can be learned in a suitable manner on the basis of training data from known states of the dynamic system in such a way that future states of the dynamic system can be predicted. In the figures described below, corresponding neuron clusters which model state vectors or observable vectors or difference vectors are represented by circles.

With the aid of recurrent neural networks, in the field of renewable energies, for example, fluctuations in electricity generation, in particular in the case of wind power installations, are estimated. For this purpose, environmental influences are modeled and, on the basis of a model learned on the basis of training data, observables such as temperature, wind strength, wind direction, pressure, etc. are used and determined in order to be able to draw conclusions about electricity generation therefrom.

Recurrent neural networks can likewise be used for the computer-aided prediction of electricity prices or energy demand or raw material prices.

FIG. 1 schematically depicts a conventional network topology that serves for modeling a dynamic system. This is a historically consistent neural network in which state vectors sₜ₋₃, sₜ₋₂, sₜ₋₁, sₜ, sₜ₊₁, sₜ₊₂ with respect to points in time t−3, t−2, t−1, t, t+1 and t+2 are used in order to derive target variable vectors yₜ₋₃, yₜ₋₂, yₜ₋₁, yₜ, yₜ₊₁, yₜ₊₂ associated with the respective points in time and consisting of observable variables or observables and hidden state variables by means of a multiplication by a matrix B. By means of the matrix B, the target variables yₜ₋₃, yₜ₋₂, yₜ₋₁, yₜ, yₜ₊₁ and yₜ₊₂ are derived in each case from the internal state vectors sₜ₋₃, sₜ₋₂, sₜ₋₁, sₜ, sₜ₊₁ and sₜ₊₂ by a linear transformation. The modeling is refined by so-called architectural teacher forcing, ATF for short, by taking account of potentially observable or measurable observable vectors uₜ₋₃, uₜ₋₂, uₜ₋₁, u, which can comprise a plurality of observables per vector, in the state transition from a state vector to the chronologically succeeding state vector. The values of the observables uₜ₋₃ influence for example the determination of the state vector sₜ₋₂ from the state vector sₜ₋₃. All entries of the observable vector uₜ₋₃ are used for this purpose. If measurement values do not exist for all entries or rows of the observable vector, then values are estimated in order that a complete time series composed of observable vectors has an influence.

For the ATF, an output layer is set to a fixed value of 0, illustrated in the figure by the circle tar=0 or target equals 0. The actually observed values in the vector uₜ₋₃ are added negatively to the output layer, illustrated by −Id in FIG. 1. From the state vector sₜ₋₃, the potentially observable observables are filtered from the state vector sₜ₋₃ simultaneously by means of the matrix [Id 0]. [Id 0] is the identity matrix having 0-entries for removing the hidden observables from the state vector. The observable states are added positively to the output layer. It is thus possible to form the difference vector between the modeled observables and the actually observed observables. Said difference vector negatively influences the state transition. From the state vector sₜ₋₃, the observable entries of the state vector sₜ₋₃ are corrected by the actually observed observable entries since, by applying the matrix

$$[ \begin{matrix}- Id \\ 0\end{matrix} ] ,$$

the difference vector, having corresponding 0-entries for the hidden states, is subtracted from the state vector. The hidden states remain unchanged as a result of the 0-entries.

Then as usual a nonlinear activation function is applied, e.g. a hyperbolic tangent function, illustrated in FIG. 1 by a circle containing tanh, and with linear components, illustrated by a weight matrix A, in order to reach the succeeding state vector sₜ₋₂ in the model.

This procedure is repeated analogously for all state vectors for which observable vectors are present historically. Owing to the quality of the state vectors that is improved in this way up to the present, and the associated improved quality of the modeled observable values, this improves in particular the quality of forecast observable values, for example the quality of the vectors yₜ₊₁, yₜ₊₂ and of the corresponding observable values.

In order to explain the learning phase of the recurrent neural network described by way of example, it should be pointed out that a bias vector so is predefined as an initial state, said bias vector being learned together with the weight matrices A and B in a learning phase of the neural network. In the modeling of the dynamic behavior of a technical system that is described by a number of observables and by hidden states, not all of the training data are taken into account all at once during the training of the network, rather the training is based on a segment of the network structure for a number of successive state vectors for which known observable vectors from training data are present. The network is thus trained in time windows which represent different segments from successive observable vectors of the training data. For cases in which no initial state exists, an initial noisy state is used, for example, which is not learned in the learning phase but rather is accepted as uncertainty.

FIG. 2 illustrates how the architectural teacher forcing from FIG. 1 is modified in order to achieve an improved modeling in the case of sparsely occupied time series. As in the case of known architectural teacher forcing, a difference vector is formed proceeding from the observable entries of the state vector sₜ₋₃ with respect to a specific point in time t−3 and proceeding from the actual observable vector uₜ₋₃ observed at this point in time. An index vector cₜ₋₃ is provided, moreover, which contains 1-entries if measurement values are actually present in the corresponding entry of the observable vector uₜ₋₃, and which contains 0-entries if the corresponding entry of the observable vector lacks the measurement value. By means of the difference vector being multiplied by the index vector—illustrated in FIG. 2 by a circle containing x—only those observables of the succeeding system state sₜ₋₂ are corrected for which actual measurement values are available in the observable vector uₜ₋₃. The difference vector filtered by the multiplication by the index vector cₜ₋₃ has only corrections for the entries for which observed measurement values are present. By applying the matrix

$$[ \begin{matrix}- Id \\ 0\end{matrix} ]$$

to the filtered difference vector, it is possible to correct the system state sₜ₋₃ with regard to the observables. Once again the activation function comprising a hyperbolic tangent function and a multiplication by matrix A is applied in order to reach the state vector sₜ₋₂ of the succeeding point in time t−2.

For each of the points in time for which measurement values which can be used for the correction method were actually detected, the described adaptation is applied in the creation of the state vectors for the improved modeling of the system. Actually detected measurement values are distinguished in the appearance of the observable vector for example by virtue of the fact that a quality property value is additionally present with respect to a measurement value supplied by a sensor. Missing entries are thus recognizable for example on the basis of an entry “not available” or the like. In the simplest case, the measurement value may also just contain an invalid value (NaN, “Not a Number”). The index vector is automatically adapted for example for each point in time after the detection of the measurement values, such that the 0- and 1-entries are present appropriately.

Even if detected measurement values make up a particularly small proportion of the total set of detectable measurement values per observable vector or if measurement values are present particularly intermittently as considered over the time range of the measurements, the small number of available measurement values can advantageously be taken into account for improving the modeling. By way of example, a measurement value for a temperature profile is present only at the points in time t−3 and t−1. Moreover, at the point in time t−3 only the measurement value for the temperature profile is present and the other potentially detectable measurement values, such as, for example, pressure or wind strength, etc., are not present at this point in time. At the other points in time t−2, t−1 and t, by way of example, the other measurement values such as pressure, wind strength, etc. are completely present. Advantageously, it is not necessary to interpolate temperature values for the intervening state or measurement value at the point in time t−2. Likewise, it is not necessary to interpolate the pressure or wind strength measurement values at the point in time t−3 and, nevertheless, it is advantageously possible to use the measurement value of the temperature present at the point in time t−3. Sparsely or intermittently occupied time series can thus be advantageously used for improved modeling in recurrent neural networks.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A method for the model-based determination of a system state of a dynamic system by means of a model,
wherein a recurrent neural network is provided as the model of the dynamic system,
wherein the model is supplied with a time series of potentially detectable measurement values, including detected and missing measurement values, as an input variable,
wherein at least one system state associated with a point in time is generated from the model, from which system state at least one target value associated with the respective point in time is determinable;
wherein chronologically successive system states are converted into one another by a respective state transition;
wherein a correction of at least one system state is carried out on the basis of the time series with the aid of the state transition;
wherein the correction is carried out without being influenced by the missing measurement values of the time series.

2. The method as claimed in claim 1, wherein the correction is carried out without being influenced by the missing measurement values of the time series by virtue of the fact that an observable vector present per point in time of the time series is multiplied by a vector, and said vector is constructed from 0-entries in such a way that the missing measurement values in the observable vector do not influence the correction of the system state as a result of the 0-entries.

3. The method as claimed in claim 1, wherein the correction is carried out without being influenced by the missing measurement values of the time series by virtue of the fact that an observable vector present per point in time of the time series is multiplied by a vector, and said vector is constructed from 1-entries in such a way that the detected measurement values in the observable vector influence the correction of the system state as a result of the 1-entries.

4. The method as claimed in claim 1, wherein the missing measurement values of the time series are not supplemented or estimated by an algorithm.

5. The method as claimed in claim 1, wherein an associated future model-based target value is determined from a system state for a point in time in the future with respect to a fixed point in time.

6. The method as claimed in claim 1, wherein a multiplicity of observable vectors of the time series with respect to past points in time influence the correction of a state vector associated with a point in time following a respective past point in time.

7. The method as claimed in claim 1, wherein the correction is carried out in a learning phase of the dynamic system or in an operating phase.

8. The method as claimed in claim 1, wherein the state transition is performed by applying a nonlinear activation function and a linear function.

9. The method as claimed in claim 1, wherein the system state is configured as a state vector composed of observables and hidden states.

10. The method as claimed in claim 9, wherein in the state transition a difference vector is applied to the observables of the state vector with respect to the associated point in time, wherein the difference vector describes a difference between the observables and known observables of an associated observable vector of the time series.

11. The method as claimed in claim 1, wherein a target value generated from a system state, forecast future target value, for the control of a technical installation, is communicated to a control unit of the technical installation or is used for optimizing the model for the correction.

12. The method as claimed in claim 1, wherein a target value generated from a system state, in particular a forecast future target value, is used for decision support or risk assessment, in particular in the context of a demand or price forecast.

13. A computer program product, comprising a computer readable hardware storage device having computer readable program code stored therein, said program code executable by a processor of a computer system to implement a method comprising a computer program having means for carrying out the method as claimed in claim 1 if the computer program is executed on a program-controlled device.
